(19) United States
(12) Patent Application Publication
(10) Pub. No.: US 2011/0300280 A1
(43) Pub. Date: Dec. 8, 2011

(54) SHELLFISH COOKING RACK

(76) Inventor: Charles R. Williams, Santa Rosa, CA (US)

(21) Appl. No.: 12/795,589

(22) Filed: Jun. 7, 2010

(51) Int. Cl. A23L 1/33; A47J 36/00; A23L 1/01; A47J 37/06

(52) U.S. Cl. 426/523; 99/450; 99/446

(57) ABSTRACT

A rack having a mesh body, a length and a width or if not rectangular, a circumference. The mesh body, in cross section, is provided with a plurality of ridges and troughs creating v-shaped surfaces sized for receiving and retaining shellfish thereon during cooking. The shellfish is placed upon the rack over the troughs and between the ridges for maintaining the shellfish in a substantially horizontal orientation during cooking.

### TECHNICAL FIELD

The present invention involves an easy to fabricate yet effective rack for supporting shellfish, such as oysters, in a substantially horizontal orientation to promote cooking while employing a wide variety of heat sources. In using the present invention, contents of the shellfish remain within the shell and do not drip therefrom thus enhancing the cooking experience. When desired, the present rack can also be used as a presentation device to enable the shellfish to go directly from the appropriate heat source to a table or countertop for serving.

### BACKGROUND OF THE INVENTION

There has never been a particularly effective means of cooking shellfish, such as oysters, that would enable heat to fully circulate about the shellfish while enabling the meat of the shellfish to cook in its own juices with properly added spices and condiments Because shellfish, such as oysters, tend to have uneven and somewhat pocked surfaces, trying to cook shellfish while resting the shells upon a flat surface produces uneven and often times highly undesirable results. The shells under such circumstances are unlikely to remain horizontally oriented and, instead, will tip and tilt depending upon their unique characteristics. Natural juices and added condiments and spices would then drip from the shell onto the cooking surface fouling the cooking surface and providing uneven cooking results as some of the shellfish would be cooked in its own juices while others would lose their liquid portions resulting in a burnt or at least overcooked product.

In addition to the above, there has not been a suggestion of providing a suitable cooking rack which not only maintains the shellfish in the appropriate horizontal orientation, but which does so inexpensively while providing openings to encourage even heating from beneath the shellfish during the cooking process.

It is thus an object of the present invention to provide a device which overcomes the obstacles presented by the prior art.

It is yet a further object of the present invention to provide a rack which is inexpensive to produce and yet allows for the cooking of shellfish while employing a wide variety of heat sources.

These and further objects will be more readily appreciated when considering the following disclosure and appended claims.

### SUMMARY OF THE INVENTION

The present invention involves a rack comprising a mesh body. The mesh body, in cross section, has a plurality of ridges and troughs creating v-shaped surfaces sized for receiving and retaining shellfish thereon during cooking. The rack can be employed in an appropriate cooking method by placing shellfish on the rack above the ridges and between the troughs when subjecting the rack to a heat source. In doing so, the shellfish remains in a substantially horizontal orientation to promote cooking without the loss of cooking liquids, condiments and spices.

### BRIEF DESCRIPTION OF THE FIGURES

FIG. 1A is a front view showing the contour of the rack of the present invention.

FIG. 1B is a front view of the rack of FIG. 1A showing support of shellfish during use.

FIGS. 2 and 3 are top plan views of the rack of the present invention used with a pan while supporting shellfish for cooking as an embodiment of the present invention.

FIG. 4 is a top plan view of the rack of the present invention used directly on a barbeque grill while supporting shellfish for cooking as yet a further embodiment of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

More important features of the invention have been broadly outlined in the summary above so that the following detailed description may be better understood and the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

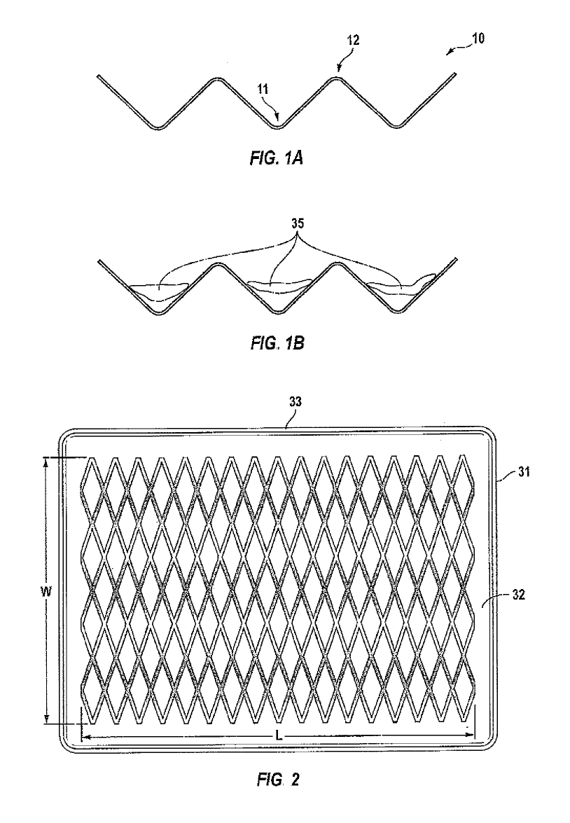

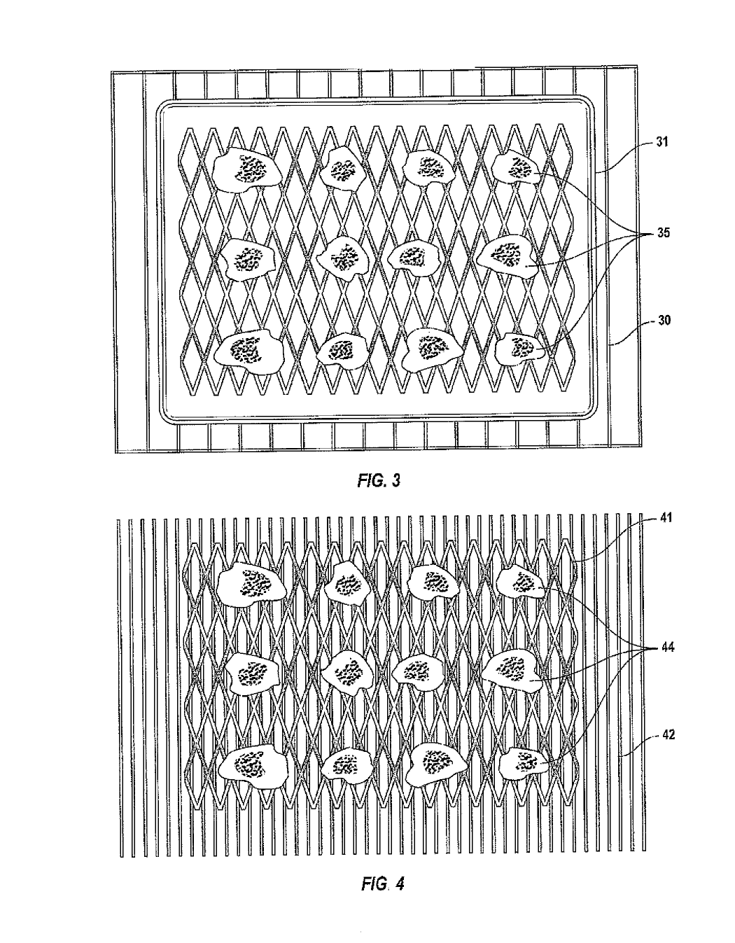

Turning first to FIGS. 1A and 2, rack 10 is depicted. Rack 10 is provided with a mesh body as shown having a length “L” and a width “W”, and if not rectangular, a circumference, and, in cross section, is provided with a plurality of ridges 12 and troughs 11 creating v-shaped surfaces.

The mesh body of rack 10 could be made from, for example, carbon steel and stainless steel Examples include raised and flattened metal sheets having ½ inch diamond patterns of ideally, 13 to 16 gauge. Although other gauges can be employed, it is found that gauges thinner than 16, such as 18 gauge, would lack durability while gauges thicket than 13, such as 9 gauge, would be difficult to fabricate. Various perforated stainless steel sheets can be employed such as described at www.mcnichols.com while other sheeting products can be used such as those offered by

### Metals Depot

Rack 10 of FIG. 1A can be applied directly to the surface of a barbeque grill such as show in FIG. 4. Specifically, tack 41 is shown on grilling rack 42 enabling a charcoal or gas heat source to travel between the mesh openings for cooking, in this instance, oysters 44 placed directly thereon.

As best shown in FIG. 1B, the rack of the present invention enables shellfish, such as oyster shells 35 to be placed between ridges 12 and above troughs 11 in a manner such that these shells remain oriented substantially horizontally during cooking. Thus, the racks of the present invention not only facilitate even heat flow between mesh openings of the racks, but maintain the shells in their substantially horizontal orientations during cooking thus preventing juices, spices and condiments from spilling from the shells and onto the cooking surface. It should further be noted that shells of virtually any size can be employed with rack 10 as smaller shells would simply nest closer to troughs 11 while larger shells would sit higher within the v-shaped cross section, in both instances, maintaining their substantially horizontal orientations.

In turning to FIGS. 2 and 3, rack 30 can also be placed upon pan 31 during cooking. In some instances, and particularly when shellfish 35 is intended to be cooked within an oven, rather than upon a barbeque grill, a sheet pan 31 can be used which includes generally planar surface 32 and edge 33 elevated from planar surface 32. In using such pans, such as a ½ sheet tray or a ¼ sheet tray, length L and width W are sized to enable the rack to reside upon planar surface 32 and within edge 33. Edge 33 would prevent the rack from being dislodged from planar surface 32 and thus enhance the cooking experience.

Although oysters were shown as the shellfish being cooked and employing the present invention, virtually any shellfish can be used while practicing the present invention. The present rack is particularly suitable for oysters for the uneven and pocked surfaces of oyster shells make the present invention particularly appealing. Simply resting such shells upon a cooking surface, be it the surface of a barbeque grill or pan will result in some of the shells tipping during the cooking process.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like.

Therefore, the above description and illustration should not be considered as limiting the scope of the invention, which is defined by the appended claims.

What is claimed is:

1. A rack comprising a mesh body which, in cross section, has a plurality of ridges and troughs creating v-shaped surfaces sized for receiving and retaining shellfish thereon during cooking.

2. The rack of claim 1 wherein said mesh body comprises a member selected from the group consisting of carbon steel and stainless steel.

3. The rack of claim 2 wherein said mesh body is comprised of said carbon steel or stainless in an expanded diamond pattern, punched or perforated carbon or sheet stainless steel.

4. The rack of claim 1 wherein said plurality of ridges and troughs are sized to receive oyster shells thereon while maintaining said oyster shells in a substantially horizontal orientation.

5. In combination, a rack and pan, said pan having a substantially planar surface and having an edge elevated from said substantially planar surface and a rack having a mesh body, said mesh body, in cross section, having a plurality of ridges and troughs creating v-shaped surfaces sized for receiving and retaining shellfish thereon during cooking, said rack being sized to reside upon said planar surface and within said edge.

6. A method of cooking shellfish comprising providing a rack, said rack comprising a mesh body, said mesh body, in cross section, having a plurality of ridges and troughs creating v-shaped surfaces sized for receiving and retaining shellfish thereon, placing said shellfish on said rack between said ridges and above said troughs and subjecting said rack to a heat source.

7. The method of claim 6 wherein said ridges and troughs are sized to receive oyster shells thereon while maintaining said oyster shells in a substantially horizontal orientation.

8. The method of claim 7 wherein said rack is used together with a pan, said pan being substantially rectangular having a substantially planar surface and an edge elevated from said substantially planar surface, placing said rack onto said substantially planar surface and within said edge.
